(19) United States
(12) Patent Application Publication
(10) Pub. No.: US 2026/0070738 A1
(43) Pub. Date: Mar. 12, 2026

(54) PICKING SYSTEM, PICKING METHOD, AND RECORDING MEDIUM RECORDING PICKING PROGRAM

(71) Applicant: Sharp Kabushiki Kaisha, Sakai City (JP)

(72) Inventor: Eiji KURIMOTO, Sakai City (JP)

(21) Appl. No.: 19/311,391

(22) Filed: Aug. 27, 2025

(30) Foreign Application Priority Data
Sep. 12, 2024 (JP) 2024-158658

(51) Int. Cl. B65G 1/137; B65G 1/06

(52) U.S. Cl. CPC B65G 1/1375; B65G 1/06; B65G 2203/0283; B65G 2207/40

(57) ABSTRACT

A picking system includes an automatic transport apparatus that transports goods, a picking station unit where a worker boards to perform picking work on the goods, a determination processing unit that determines a disposition position of the picking station unit, and a movement processing unit that moves the picking station unit to the disposition position.

### INCORPORATION BY REFERENCE

This application is based upon and claims the benefit of priority from the corresponding Japanese Patent Application No. 2024-158658 filed on Sep. 12, 2024, the entire contents of which are incorporated herein by reference.

### BACKGROUND

The present disclosure relates to a technology for picking goods stored in storage shelves.

In the related art, in a warehouse where goods are stored, a system for moving a storage shelf to a picking station where a worker performs picking work, in response to an order, is known. For example, a system that determines a picking station that is a movement destination of a storage shelf from among a plurality of picking stations in accordance with an amount of work in progress calculated based on the number of goods to be picked at the picking station has been proposed.

However, in a system of the related art, a picking station is fixed at a predetermined place and a worker needs to perform picking work at the place, which results in problems such as a long standby time until a storage shelf arrives at the picking station or a long time required to replace the storage shelf, thereby reducing the efficiency of the picking work.

### SUMMARY

An object of the present disclosure is to provide a picking system, a picking method, and a recording medium recording a picking program capable of improving the efficiency of the picking work.

A picking system according to an aspect of the present disclosure includes an automatic transport apparatus that transports goods; picking station units where a worker boards to perform picking work on the goods; a determination processing unit that determines disposition positions of the picking station units, and a movement processing unit that moves the picking station units to the disposition positions.

A picking method according to another aspect of the present disclosure is a picking method for supporting picking work in a system including an automatic transport apparatus that transports goods and a picking station unit where a worker boards to perform picking work on the goods. The picking method includes executing, by one or more processors, determining a disposition position of the picking station unit; and moving the picking station unit to the disposition position.

A recording medium according to another aspect of the present disclosure is a recording medium having a program recorded thereon to support picking work in a system including an automatic transport apparatus that transports goods and a picking station unit where a worker boards to perform picking work on the goods. The picking program is a program for causing one or more processors to execute determining a disposition position of the picking station unit; and moving the picking station unit to the disposition position.

According to the present disclosure, it is possible to provide a picking system, a picking method, and a recording medium recording a picking program capable of improving the efficiency of the picking work.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating a configuration of a picking system according to an embodiment of the present disclosure.

FIG. 2 is a schematic diagram illustrating a configuration of a facility to which the picking system according to the embodiment of the present disclosure is applied.

FIG. 3 is a diagram illustrating an example of a disposition of storage shelves disposed in a facility to which the picking system according to the embodiment of the present disclosure is applied.

FIG. 4 is a diagram illustrating a state in which an automatic transport apparatus according to an embodiment of the present disclosure transports a storage shelf.

FIG. 5 is a side view illustrating a configuration of a picking station unit according to an embodiment of the present disclosure.

FIG. 6 is a perspective view illustrating a configuration of the picking station unit according to the embodiment of the present disclosure.

FIG. 7 is a top view illustrating the configuration of the picking station unit according to the embodiment of the present disclosure.

FIG. 8 is a diagram illustrating a state change (posture change) of an arm of the picking station unit according to the embodiment of the present disclosure.

FIG. 9 is a side view illustrating a second state of the picking station unit according to the embodiment of the present disclosure.

FIG. 10 is a perspective view illustrating a specific configuration of an arm and a communication tag of the picking station unit according to the embodiment of the present disclosure.

FIG. 11 is a diagram illustrating an example of tag status information used in the picking system according to the embodiment of the present disclosure.

FIG. 12 is a diagram illustrating an example of AGV status information used in the picking system according to the embodiment of the present disclosure.

FIG. 13A is a diagram illustrating an example of a connection pattern of the picking station unit according to the embodiment of the present disclosure.

FIG. 13B is a diagram illustrating an example of the connection pattern of the picking station unit according to the embodiment of the present disclosure.

FIG. 13C is a diagram illustrating an example of the connection pattern of the picking station unit according to the embodiment of the present disclosure.

FIG. 13D is a diagram illustrating an example of the connection pattern of the picking station unit according to the embodiment of the present disclosure.

FIG. 14 is a diagram illustrating a specific example of a first disposition combination pattern according to an embodiment of the present disclosure.

FIG. 15 is a diagram illustrating a specific example of a second disposition combination pattern according to an embodiment of the present disclosure.

FIG. 16 is a diagram illustrating a specific example of a third disposition combination pattern according to an embodiment of the present disclosure.

FIG. 17 is a diagram illustrating a specific example of a fourth disposition combination pattern according to an embodiment of the present disclosure.

FIG. 18 is a flowchart showing an example of a procedure of a picking process executed by the picking system according to the embodiment of the present disclosure.

### DETAILED DESCRIPTION

Hereinafter, an embodiment of the present disclosure will be described with reference to the accompanying drawings for an understanding of the disclosure. Note that the following embodiments are specific examples of the disclosure, and do not limit the technical scope of the disclosure.

### Picking System 10

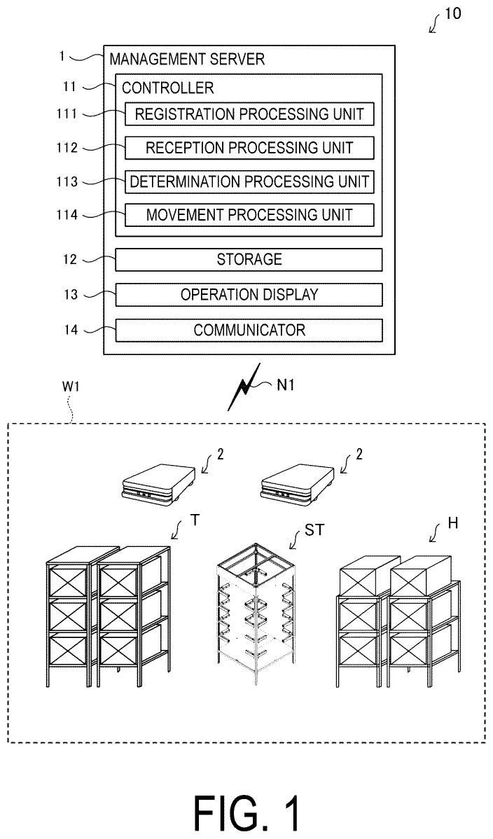

As illustrated in FIG. 1, the picking system 10 according to the embodiment of the present disclosure includes a management server 1, an automatic transport apparatus 2 (AGV, also called an unmanned transport apparatus), a storage shelf T that stores goods to be picked, a picking station unit ST in which the worker performs work for picking goods, and a shipping shelf H that stores the picked goods. The management server 1 and the automatic transport apparatus 2 can communicate with each other via a communication network N1 such as a wireless LAN.

The picking system 10 includes a traveling system that can detect a plurality of tags disposed on a floor surface and guide the automatic transport apparatus 2. For example, the automatic transport apparatus 2 travels along a preset traveling route while detecting a two-dimensional code (or a marker or the like) disposed (affixed) on the floor surface. The picking system 10 includes one or more automatic transport apparatuses 2.

Further, in a travel area in which a plurality of paths in which the automatic transport apparatus 2 can travel are set, the picking system 10 designates, as a traveling route, a path to travel among the plurality of paths along which the automatic transport apparatus 2 can travel, and transports the transport target from a storage position to a destination position. The picking system 10 is applied to a facility such as a factory, warehouse, or the like that stores products. For example, when the picking system 10 receives an order for a product from a customer (customer terminal), the picking system 10 outputs a travel instruction (transport request) to the automatic transport apparatus 2. When the automatic transport apparatus 2 acquires the travel instruction, the automatic transport apparatus 2 moves to the storage position (storage shelf T) of the product, connects to the storage shelf T, and transports the storage shelf T to the picking station unit ST in a picking area. In the picking area, a worker boarding the picking station unit ST takes out a target product (ordered product) from the storage shelf T and stores the target product on the shipping shelf H waiting in the picking area. The automatic transport apparatus 2 connects the shipping shelves H and transports the shipping shelves H to the shipping area. The customer can order products by accessing a website (order page) that is operated by an order server (not shown) using an information processing device (customer terminal) such as a personal computer or smartphone.

The order server can receive an order for products from each of a plurality of customer terminals, aggregate the received order information, and output the order information to the management server 1. The management server 1 manages an operation of each of the plurality of automatic transport apparatuses 2 and outputs the travel instruction to each automatic transport apparatus 2 based on the order information. The automatic transport apparatus 2 automatically travels along a preset traveling route based on the travel instruction, and moves the storage shelf T storing the product included in the order information to the picking area. Further, the automatic transport apparatus 2 moves the shipping shelf H to the picking area based on the travel instruction. Further, the automatic transport apparatus 2 moves the picking station unit ST to a predetermined position (disposition position) in the picking area based on the travel instruction.

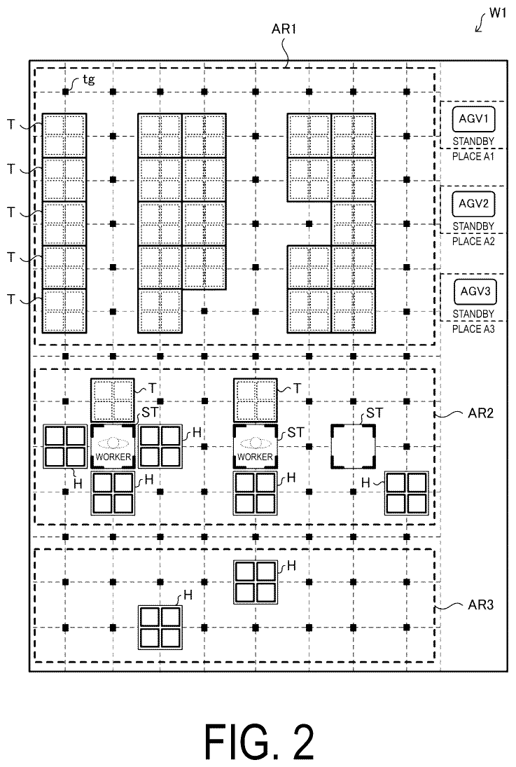

FIG. 2 illustrates an example of a facility W1 to which the picking system 10 is applied. In the facility W1 illustrated in FIG. 2, a plurality of storage shelves T that store products are disposed in a storage area AR1, a plurality of picking station units ST for performing the picking work are disposed in a picking area AR2, and a plurality of shipping shelves H that receive products in the picking work are disposed in a shipping area AR3. Further, a standby place for the automatic transport apparatus 2 is set in the facility W1. For example, a standby place A1 where an AGV1 (automatic transport apparatus 2) waits, a standby place A2 where an AGV2 (automatic transport apparatus 2) waits, and a standby place A3 where an AGV3 (automatic transport apparatus 2) waits are set in the facility W1. Each automatic transport apparatus 2 waits at a predetermined standby place when a travel instruction is not received from the management server 1.

Further, a tag tg is disposed on the floor surface in an area in which the automatic transport apparatus 2 can travel in the facility W1. The tag tg is configured as a two-dimensional code, a marker, an RFID, or the like. The area in which the tag tg is disposed is an area in which the automatic transport apparatus 2 can travel. Further, as illustrated in FIG. 2, the tags tg are disposed at equal intervals in positions at which the storage shelves T, the picking station units ST, and the shipping shelves H are disposed, and in a path between the storage shelves T, the picking station units ST, and the shipping shelves H. Further, a plurality of tags tg are disposed at equal intervals in areas (passage areas) in which the storage shelves T, the picking station units ST, and the shipping shelves H are not disposed.

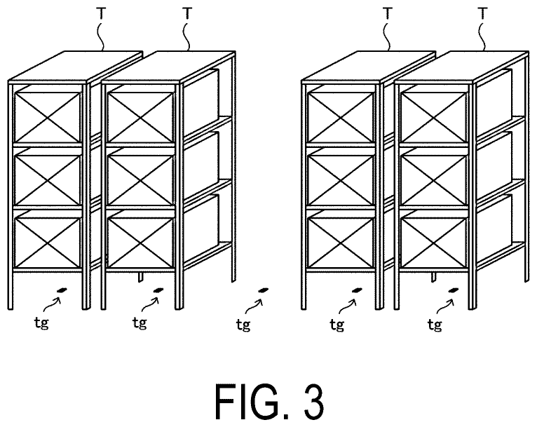

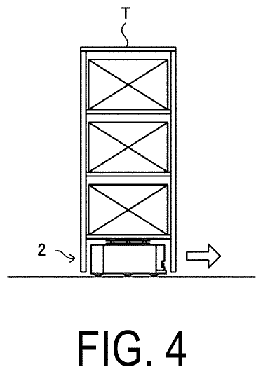

For example, as illustrated in FIG. 3, the tags tg are disposed at center positions of the storage shelves T (below the storage shelves T) and center positions between adjacent storage shelves T (paths). The storage shelves T include a plurality of storage shelves (three storage shelves in FIG. 3) on which products are disposed, and a space (entrance portion) through which the automatic transport apparatus 2 can enter is formed at a bottom. As illustrated in FIG. 4, when the automatic transport apparatus 2 arrives at the storage shelf T storing the target product, the automatic transport apparatus 2 can slip under the storage shelf T, connect to (lift) the storage shelf T using a connection portion, and move together with the storage shelf T. The automatic transport apparatus 2 of the present embodiment has a configuration in which the automatic transport apparatus 2 lifts the storage shelf T and moves, but in another embodiment, when the storage shelf T has wheels, the automatic transport apparatus 2 may be configured to tow the storage shelf T.

Further, since the space is formed at a bottom of the storage shelf T, the automatic transport apparatus 2 can pass under the storage shelf T. That is, in the present embodiment, not only an area in which the storage shelf T is not disposed (an area between the storage shelves T), but also an area in which the storage shelf T is disposed (an area below the storage shelf T) can be used as a path in which the automatic transport apparatus 2 can travel. When the shipping shelf H has the same configuration as the storage shelf T and the automatic transport apparatus 2 arrives at the shipping shelf H, the automatic transport apparatus 2 can slip under the shipping shelf H, connect to (lift) the shipping shelf H using a connection portion, and move together with the shipping shelf H.

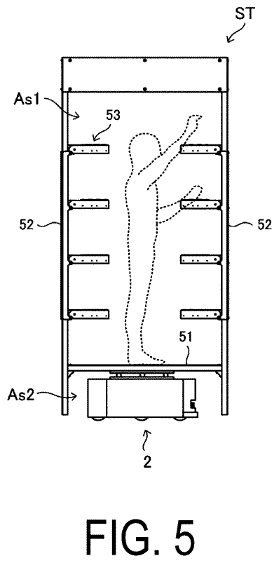

Further, as illustrated in FIG. 5, when the picking station unit ST also has the same configuration as the storage shelf T and the automatic transport apparatus 2 arrives at the picking station unit ST, the automatic transport apparatus 2 can slip under the picking station unit ST (an entrance portion As2), connect to (lift) the picking station unit ST using a connection portion, and move together with the picking station unit ST.

When each automatic transport apparatus 2 acquires a travel instruction from the management server 1, the automatic transport apparatus 2 moves each of the storage shelf T, the picking station unit ST, and the shipping shelf H to a predetermined position. For example, when the automatic transport apparatus 2 acquires a travel instruction including order information from the management server 1, the automatic transport apparatus 2 moves to the position of the picking station unit ST along a traveling route generated in accordance with its current position, connects to (load) the picking station unit ST, and moves (transports) the picking station unit ST to a predetermined disposition position within the picking area AR2. Further, when the automatic transport apparatus 2 acquires the travel instruction from the management server 1, the automatic transport apparatus 2 moves to the position of the storage shelf T along the traveling route generated in accordance with the current position, connects to (loads) the storage shelf T, and moves (transports) the storage shelf T to a position (the disposition position) of the picking station unit ST in the picking area AR2. Further, when the automatic transport apparatus 2 acquires the travel instruction from the management server 1, the automatic transport apparatus 2 moves to the position of the shipping shelf H along the traveling route generated in accordance with the current position, and connects to (loads) the shipping shelf H to move (transports) the shipping shelf H to the position of the picking station unit ST in the picking area AR2 (the disposition position). The automatic transport apparatus 2 that moves the storage shelf T, the picking station unit ST, and the shipping shelf H may be the same AGV or may be different AGVs.

The picking system 10 sequentially detects the plurality of tags tg disposed on the floor surface and travels, and controls the travel of the automatic transport apparatus 2 that can transport the movement targets (the storage shelf T, the picking station unit ST, and the shipping shelf H) disposed at positions corresponding to some of the plurality of tags tg to the specified position. Each movement target can be moved within the facility W1 by the automatic transport apparatus 2. In the example illustrated in FIG. 2, the facility is divided into the storage area AR1, the picking area AR2, and the shipping area AR3, but each area may be set as one area. For example, the picking station unit ST may move to the storage area AR1 of the storage shelf T to perform the picking work, or the picking station unit ST may move to the shipping area AR3 of the shipping shelf H to perform the picking work.

Further, in the storage shelf T and the shipping shelf H, the goods (products) may be accommodated in containers (storage boxes) disposed on the shelves of each stage, or may be disposed directly on the shelves of each stage.

In the present embodiment, the picking system 10 corresponds to the picking system according to the present disclosure, but the picking system according to the present disclosure may be configured of the management server 1 alone or may include one or more components of the management server 1 and the automatic transport apparatus 2.

### Picking Station Unit ST

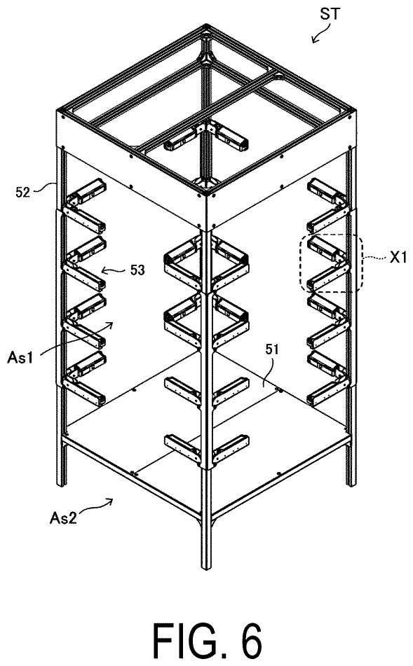

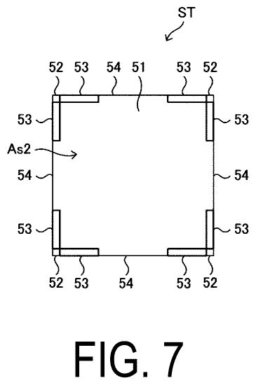

A specific configuration of the picking station unit ST will be described. FIG. 5 shows a side view of the picking station unit ST, FIG. 6 shows an external perspective view of the picking station unit ST, and FIG. 7 shows a top view of the picking station unit ST.

The picking station unit ST is a device in which the worker boards to perform picking work on goods. Specifically, the picking station unit ST includes a stage 51 on which the worker rides, pillars 52 located at an end portion of the stage 51 and extending upward from the stage 51, and an arm 53 extending laterally from the pillar 52 along a boundary portion 54 between an area of the stage 51 and an area outside the stage 51. The stage 51 has a polygonal shape when viewed from above, and the pillar 52 is disposed at each of the plurality of corners of a polygon on the stage 51. Further, the boundary portion 54 is formed between each of the plurality of adjacent pillars 52.

For example, the pillars 52 include a first pillar 52 located at a first end portion of the stage 51 and a second pillar 52 located at a second end portion of the stage 51, and the arms 53 include a first arm 53 extending laterally from the first pillar 52 along a first boundary portion 54 located between the first pillar 52 and the second pillar 52, and a second arm 53 extending laterally from the second pillar 52 along the first boundary portion 54.

Specifically, as illustrated in FIGS. 6 and 7, when focusing on one side of the picking station unit ST, for example, the left arm 53 provided on the left pillar 52 extends to the right from the left pillar 52 along the boundary portion 54 located between the left pillar 52 and the right pillar 52, and the right arm 53 provided on the right pillar 52 extends to the left from the right pillar 52 along the boundary portion 54. That is, the arms 53 extend from both the left and right ends toward the center along the boundary portion 54 on each side of the picking station unit ST. Further, a predetermined gap is formed between the left and right arms 53 on each side. The gap may be wide enough for the worker to pass through.

Further, the arms 53 are provided in a plurality of stages at predetermined intervals in a vertical direction of the picking station unit ST. In the example illustrated in FIG. 6, the arms 53 are provided in four stages. The number of stages of the arms 53 is set to match the number of stages of the storage shelf T, for example. Therefore, when the storage shelf T has three stages (see FIG. 3), the arms 53 are provided in three stages.

Further, the arm 53 can be changed between a first state (first posture) in which the arm 53 extends horizontally from the pillar 52 along the boundary portion 54, and a second state (second posture) in which the arm 53 extends vertically along the pillar 52.

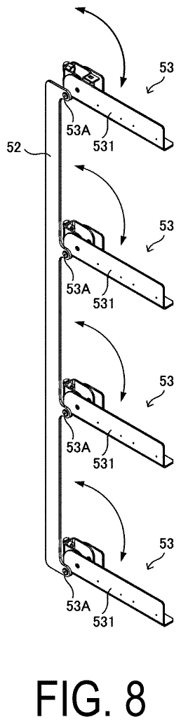

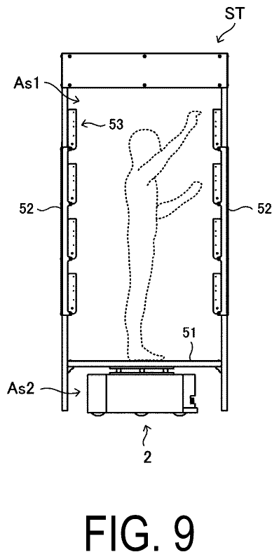

Specifically, as illustrated in FIG. 8, the arm 53 is provided on the pillar 52 so that an arm body 531 can rotate up and down by a predetermined angle (for example, 90 degrees) with a rotation axis 53A as a fulcrum, and can be changed between the first state (state illustrated in FIGS. 5 and 8) in which the arm extends horizontally from the pillar 52 and the second state (state illustrated in FIG. 9) in which the arm extends vertically (upward) from the pillar 52. For example, when the worker grips the arm 53 and rotates the arm 53 with the rotation axis 53A as a fulcrum, the arm 53 can be changed to the first state or the second state. A mechanism in which four stages of arms 53 disposed vertically are connected may be used, and when the worker rotates one arm 53 (one stage), all the arms 53 rotate in conjunction with each other.

When the arm 53 is in the second state (see FIG. 9), a side opening of the picking station unit ST is widened, and therefore, the worker can easily move between the area of the stage 51 and the area outside the stage 51 across the boundary portion 54.

A space where the worker can board is formed above the stage 51 inside the picking station unit ST. Specifically, as illustrated in FIGS. 5 to 7, a space where a person can enter is formed inside the picking station unit ST (in an area surrounded by each boundary portion 54), and this space becomes a work space As1 for the picking work. When the worker performs the picking work, the worker enters the work space As1 across the boundary portion 54, and when the picking work is completed, the worker exits the work space As1 across the boundary portion 54.

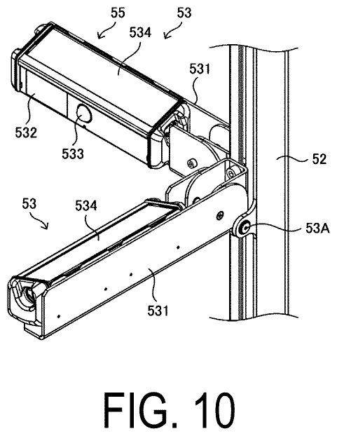

FIG. 10 shows an enlarged view of a portion X1 illustrated in FIG. 6. As illustrated in FIG. 10, each arm 53 is provided with a display 532 that displays information on the picking work, a notification unit (LED 533) that notifies of a position of a picking target, and a power supply unit (solar cell 534) that supplies power to the display 532 and the LED 533. Further, the display 532, the LED 533, and the solar cell 534 constitute an integrated communication tag 55, and the communication tag 55 is attached to the arm body 531. The communication tag 55 has a communication function and is capable of data communication with the management server 1, and for example, the communication tag 55 displays information such as a product name of the product that is a picking target, a shelf number of the storage shelf T storing the product, and a shelf number of the shipping shelf H in which the product is to be stored on the display 532 and turns on the LED 533 in response to an instruction received from the management server 1. Further, when the worker finishes the picking work for the product that is a picking target and presses a button of the LED 533, the communication tag 55 transmits information indicating that the picking work for the product has ended to the management server 1, resets display content of the display 532, and turns off the LED 533. Thus, the arm 53 has a function of forming the work space As1 to prevent the worker from falling out of the work space As1, and a function of displaying picking information.

The picking station unit ST includes an entrance portion As2 through which the automatic transport apparatus 2 can enter between the stage 51 and the floor surface on which the picking station unit ST is disposed, and is configured to be movable on the floor surface by the automatic transport apparatus 2. Specifically, as illustrated in FIG. 5, the entrance portion As2 through which the automatic transport apparatus 2 can enter is formed at a lower portion of the picking station unit ST, and when the automatic transport apparatus 2 arrives at the picking station unit ST, the automatic transport apparatus 2 slips into the entrance portion As2, connects to (lifts) the picking station unit ST using a connection portion, and moves together with the picking station unit ST. The automatic transport apparatus 2 may move the picking station unit ST in a state in which the worker boards the picking station unit ST, or may move the picking station unit ST on the condition that the worker does not board the picking station unit ST.

The picking station unit ST having the above-described configuration is disposed in the picking area AR2 in the facility W1. There may be one picking station unit ST, or there may be a plurality of picking station units ST. Further, the picking station unit ST may be movable only within the picking area AR2, may be movable within the storage area AR1, or may be movable within the shipping area AR3.

As described above, the picking station unit ST can be moved to a predetermined disposition position due to travel processing of the automatic transport apparatus 2 in response to the travel instruction from the management server 1, and is configured so that the worker can perform the picking work within the picking station unit ST. A specific example of the picking work will be described later.

### Management Server 1

As illustrated in FIG. 1, the management server 1 is a server including a controller 11, a storage 12, an operation display 13, a communicator 14, and the like. Note that the management server 1 is not limited to being a single computer, and may be a computer system in which a plurality of computers operate in cooperation with each other. The various types of processing executed by the management server 1 may be distributed and executed by one or more processors.

The communicator 14 is a communication interface that connects the management server 1 to the communication network N1 by wire or wirelessly and executes data communication in accordance with a predetermined communication protocol with the automatic transport apparatus 2 and the communication tag 55 (see FIG. 10) installed in the picking station unit ST via the communication network N1.

The operation display 13 is a user interface that includes a display such as a liquid crystal display or an organic EL display that displays various types of information, and an operation unit such as a mouse, keyboard, or touch panel that accepts operations.

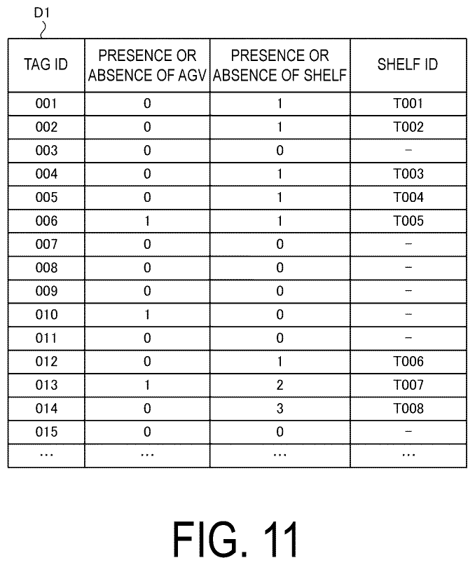

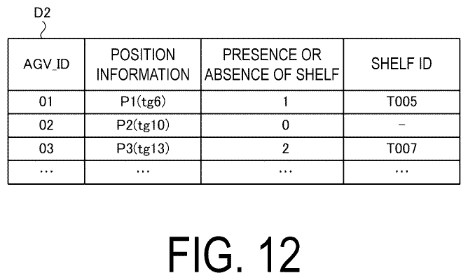

The storage 12 is a non-volatile storage such as a hard disk drive (HDD), a solid state drive (SSD), or flash memory that stores various types of information. Specifically, the storage 12 stores data such as tag status information D1 (see FIG. 11) and AGV status information D2 (see FIG. 12). Current status information indicating whether or not a shelf (the storage shelf T, the picking station unit ST, and the shipping shelf H) exists at a position of each tag tg and whether or not an automatic transport apparatus 2 (AGV) exists is registered in the tag status information D1. Current status information indicating the current position of each AGV and whether or not the shelf is being moved is registered in the AGV status information D2.

As illustrated in FIG. 11, the tag status information D1 includes information such as “tag ID”, “presence or absence of AGV”, “presence or absence of shelf”, and “shelf ID” corresponding to each tag tg. The tag ID is identification information of the tag tg. The presence or absence of AGV is information indicating whether or not an AGV exists at the position of the tag tg, with “0” indicating that an AGV does not exist at the position of the tag tg and “1” indicating that the AGV exists at the position of the tag tg.

The presence or absence of the shelf is information indicating whether or not the shelf exists at the position of the tag tg, with “0” indicating that no shelf exists at the position of the tag tg, “1” indicating that a storage shelf T exists at the position of the tag tg, “2” indicating that the picking station unit ST exists at the position of the tag tg, and “3” indicating that the shipping shelf H exists at the position of the tag tg. The shelf ID is shelf identification information, and indicates the identification information of each of the storage shelf T, the picking station unit ST, and the shipping shelf H.

The controller 11 acquires information from each AGV, such as a travel position and the presence or absence of the shelf (storage shelf T, picking station unit ST, and shipping shelf H) (whether or not the shelf is being transported), and updates the tag status information D1 in real time.

As illustrated in FIG. 12, the AGV status information D2 includes information such as the corresponding “AGV_ID”, “position information”, “presence or absence of the shelf”, and “shelf ID” for each AGV. The AGV_ID is identification information for the AGV (the automatic transport apparatus 2), and AGV_IDs “01” to “03” correspond to AGV1 to AGV3, respectively. The position information is information indicating a current position of the AGV, and is, for example, coordinate information (X and Y coordinates) on a coordinate plane of the map corresponding to the facility W1. For example, position information “P1” indicates the current position of the AGV1 and corresponds to the position (coordinates) of the tag tg6. Further, position information “P2” indicates the current position of the AGV2 and corresponds to the position (coordinates) of the tag tg10, and position information “P3” indicates the current position of the AGV3 and corresponds to the position (coordinates) of the tag tg13.

The presence or absence of the shelf is information indicating whether the AGV is transporting the shelf (the storage shelf T, the picking station unit ST, and the shipping shelf H), with “0” indicating a state in which the AGV is not transporting the shelf (a state in which the AGV is not loading the shelf or a state in which AGV is towing the shelf), “1” indicating a state in which the AGV is transporting the storage shelf T (a state in which the AGV is not loading the storage shelf T1 or a state in which the AGV is towing the storage shelf T1), “2” indicating a state in which the AGV is transporting the picking station unit ST (a state in which the AGV is not loading the picking station unit ST or a state in which the AGV is towing the picking station unit ST), and “3” indicating a state in which the AGV is transporting the shipping shelf H (a state in which the AGV is not loading the shipping shelf H or a state in which the AGV is towing the shipping shelf H).

The shelf ID is shelf identification information, and indicates identification information for the storage shelf T, the picking station unit ST, and the shipping shelf H.

The controller 11 acquires information from each AGV, such as a travel position and the presence or absence of a shelf (whether or not the shelf is transported), and updates the AGV status information D2 in real time.

The storage 12 may store data such as product information, order information, transport information, and map data. The product information includes information on products stored in the facility W1 (for example, a product name, product code, shipping frequency, sales level, and arrival information). The order information includes information on customer orders. The transport information includes information on a storage position of products corresponding to customer orders. The map data includes disposition information (coordinate information) of the tags tg disposed on a floor surface of the facility W1.

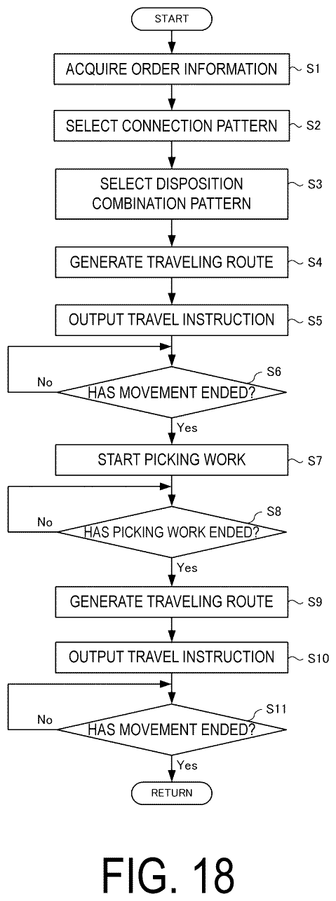

Further, as another embodiment, all or all of the tag status information D1, AGV status information D2, product information, order information, transport information, and map data may be stored in another server accessible from the management server 1 via the communication network N1. In this case, the controller 11 of the management server 1 may acquire the information from the other server and execute various processes such as a picking process (see FIG. 18) to be described below.

Further, the storage 12 stores a control program such as a picking program for causing the controller 11 to execute a picking process to be described below. For example, the picking program is non-temporarily recorded on a computer-readable recording medium such as a CD or DVD, and is read by a reading device (not shown) such as a CD drive or DVD drive included in the management server 1, and stored in the storage 12.

The controller 11 includes control devices such as a CPU, a ROM, and a RAM. The CPU is a processor that performs various types of arithmetic processing. The ROM is a non-volatile storage that stores, in advance, control programs such as a Basic Input/Output System (BIOS) and an Operating System (OS) for causing the CPU to perform various types of arithmetic processing. The RAM is a volatile or non-volatile storage that stores various types of information and is used as a temporary storage memory (work area) for the various types of processing performed by the CPU. The controller 11 controls the management server 1 by executing various control programs stored in the ROM or the storage 12 in advance with the CPU.

Specifically, as illustrated in FIG. 1, the controller 11 includes various processing units such as a registration processing unit 111, a reception processing unit 112, a determination processing unit 113, and a movement processing unit 114. The controller 11 functions as various processing units described above by executing various processes in accordance with the picking program with the CPU. Further, some or all of the processing units may be configured as electronic circuits. The picking program may be a program for causing a plurality of processors to function as the processing units.

The registration processing unit 111 registers tag status information D1 (see FIG. 11) in which, for each of the plurality of tags tg, information on the presence or absence of the AGV and the presence or absence of the shelf (the storage shelf T, the picking station unit ST, and the shipping shelf H) are associated with the tag ID. Further, the registration processing unit 111 registers AGV status information D2 (see FIG. 12) in which a current position (position information) of the AGV and the presence or absence of the shelf are associated with the AGV_ID for each AGV.

The registration processing unit 111 determines whether an AGV is present at the position of the tag tg and whether a shelf is present based on the preregistered disposition information (coordinate information) of the tag tg and disposition information (coordinate information) of the shelf and the current position (position information) and the presence or absence of the shelf acquired from each AGV in real time, and registers this in the tag status information D1, and the registration processing unit 111 determines the current position of the AGV and whether the shelf is being transported for each AGV and registers this in the AGV status information D2. The registration processing unit 111 updates the tag status information D1 and AGV status information D2 in real time while each AGV is traveling.

The reception processing unit 112 receives a product shipping request. Specifically, the reception processing unit 112 receives order information corresponding to a customer's order. When the reception processing unit 112 receives the order information, the reception processing unit 112 generates the transport information.

The determination processing unit 113 determines the disposition position of the picking station unit ST based on the order information. Specifically, the determination processing unit 113 selects one connection pattern from among a plurality of preregistered connection patterns based on attribute information of the product that is a picking target that is included in the order information. Here, for example, two picking station units ST can be connected to each other via the respective boundary portions 54. Further, a space (work space) in which a worker can move is formed inside the two connected picking station units ST.

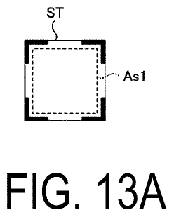

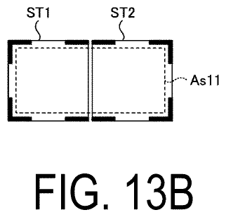

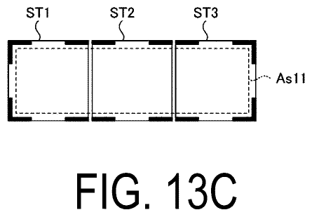

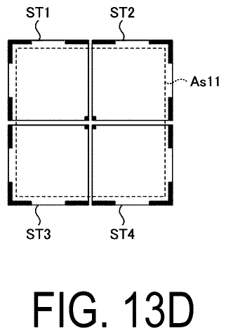

The plurality of connection patterns include a plurality of connection patterns with different numbers of picking station units ST to be connected. For example, the plurality of connection patterns include a first connection pattern in which there is one picking station unit ST (see FIG. 13A), a second connection pattern in which two picking station units ST1 and ST2 are disposed adjacent to each other and respective work spaces As1 are connected to form one work space As11 (see FIG. 13B), a third connection pattern in which three picking station units ST1 to ST3 are disposed side by side in the same direction and respective work spaces As1 are connected to form one work space As11 (see FIG. 13C), and a fourth connection pattern in which four picking station units ST1 to ST4 are disposed adjacent to each other in vertical and horizontal directions and respective work spaces As1 are connected to form one work space As11 (see FIG. 13D). The connection patterns are not limited thereto, and include various connection patterns in accordance with the number of picking station units ST. When a plurality of work spaces As1 are connected to form one work space As11, the worker can move within the plurality of picking station units ST, that is, can move within the work space As11.

When the plurality of work spaces As1 are connected to form one work space As11, it is preferable to change the arm 53 located at the boundary portion 54 between the adjacent picking station units ST to the second state (see FIG. 9) in which the arm 53 extends vertically (upward) so that the worker easily moves in the work space As11.

The determination processing unit 113 selects one connection pattern from among the plurality of preregistered connection patterns based on attribute information of goods that are picking targets, such as the shipping frequency and sales level of the product that is a picking target. Specifically, the determination processing unit 113 selects a connection pattern with a larger number of picking station units ST for a higher shipping frequency (higher sales level) of the product that is a picking target, and selects a connection pattern with a smaller number of picking station units ST for a lower shipping frequency (lower sales level).

Thus, the determination processing unit 113 determines whether to dispose a single picking station unit ST (see FIG. 13A) or to connect and dispose a plurality of picking station units ST, and further determines the connection pattern (for example, the connection pattern in FIGS. 13B to 13C) to be used for disposition when the plurality of picking station units ST are connected and disposed.

In the present disclosure, the “connection” of the picking station units ST may mean that the plurality of picking station units ST are disposed close to each other so that the respective work spaces As1 are coupled to form a single work space As11 (see FIGS. 13B to 13D), or that the plurality of picking station units ST are physically connected to each other so that the respective work spaces As1 are coupled to form the single work space As11. In other words, the plurality of picking station units ST corresponding to the connection pattern may be disposed at predetermined intervals or may be disposed in contact (connection) with each other.

Further, in the present embodiment, at least one of the storage shelves T and the shipping shelves H can be disposed adjacent to the boundary portion 54 with respect to the picking station unit ST. The controller 11 disposes at least one of the storage shelves T and the shipping shelves H with respect to the picking station unit ST disposed at the disposition position in accordance with the connection pattern, in a predetermined combination pattern (hereinafter, a “disposition combination pattern”).

Specifically, the determination processing unit 113 selects one disposition combination pattern from among a plurality of preregistered disposition combination patterns for the respective shelves (the storage shelf T, the picking station unit ST, and the shipping shelf H). Specifically, the determination processing unit 113 selects one disposition combination pattern from among the plurality of preregistered disposition combination patterns based on the attribute information of the goods that are picking targets included in the order information.

The plurality of disposition combination patterns include a plurality of disposition combination patterns in which a ratio of the number of storage shelves T to the number of shipping shelves H is different. The plurality of disposition combination patterns include a plurality of disposition combination patterns in which a ratio of the number of storage shelves T to the number of shipping shelves H is different in accordance with the connection pattern of the picking station units ST.

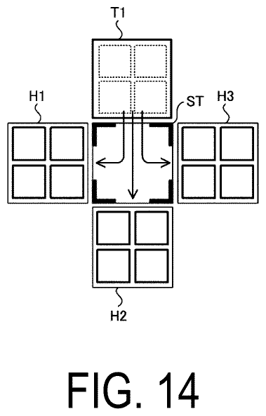

FIG. 14 illustrates a specific example of a first disposition combination pattern. The first disposition combination pattern is a pattern in which, for one picking station unit ST, the storage shelf T1 is disposed adjacent to the boundary portion 54 of a first side (an upper side in FIG. 14), the shipping shelf H1 is disposed adjacent to the boundary portion 54 of a second side (a left side in FIG. 14), the shipping shelf H2 is disposed adjacent to the boundary portion 54 of a third side (an lower side in FIG. 14), and the shipping shelf H3 is disposed adjacent to the boundary portion 54 of a fourth side (a right side in FIG. 14). In the first disposition combination pattern, the worker in the picking station unit ST picks up the products from the storage shelf T1 and stores the products in the respective shipping shelves H1 to H3. In the first disposition combination pattern, when a plurality of orders for the same products are received, the products can be stored simultaneously on a plurality of shipping shelves H corresponding to the respective orders, and therefore, the determination processing unit 113 selects the first disposition combination pattern, for example, when order information for a product with a high shipping frequency (high sales level) is acquired. In the second connection pattern (see FIG. 13B) in which the two picking station units ST are connected, one storage shelf T and five shipping shelves H may be disposed around the two picking station units ST, or two storage shelves T and four shipping shelves H may be disposed.

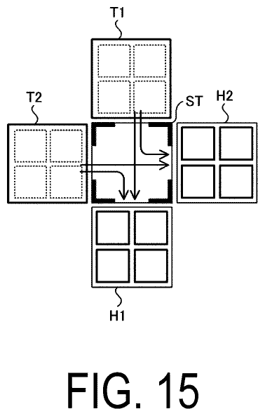

FIG. 15 illustrates a specific example of a second disposition combination pattern. The second disposition combination pattern is a pattern in which, for one picking station unit ST, the storage shelf T1 is disposed adjacent to the boundary portion 54 of a first side (an upper side in FIG. 15), the storage shelf T2 is disposed adjacent to the boundary portion 54 of a second side (a left side in FIG. 15), the shipping shelf H1 is disposed adjacent to the boundary portion 54 of a third side (a lower side in FIG. 15), and the shipping shelf H2 is disposed adjacent to the boundary portion 54 of a fourth side (a right side in FIG. 15). In the second disposition combination pattern, the worker in the picking station unit ST picks up products from the storage shelves T1 and T2 and stores the products in the shipping shelves H1 and H2. In the second disposition combination pattern, when a plurality of orders for different products are received, the products can be stored simultaneously in a plurality of shipping shelves corresponding to the respective orders, and therefore, the determination processing unit 113 selects the second disposition combination pattern, for example, if a plurality of orders including a plurality of products are received or if the shipping frequency is medium (the sales level is medium). In the case of the second connection pattern (see FIG. 13B) in which the two picking station units ST are connected, three storage shelves T and three shipping shelves H may be disposed around the two picking station units ST.

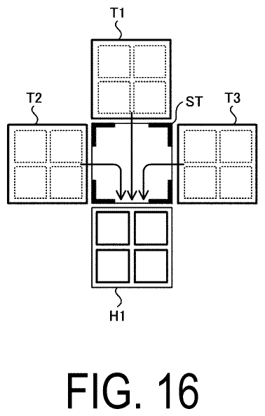

FIG. 16 illustrates a specific example of a third disposition combination pattern. The third disposition combination pattern is a pattern in which, for one picking station unit ST, the storage shelf T1 is disposed adjacent to the boundary portion 54 of a first side (an upper side in FIG. 16), the storage shelf T2 is disposed adjacent to the boundary portion 54 of a second side (a left side in FIG. 16), the storage shelf T3 is disposed adjacent to the boundary portion 54 of a fourth side (the right side in FIG. 16), and the shipping shelf H1 is disposed adjacent to the boundary portion 54 of a third side (a lower side in FIG. 16). In the third disposition combination pattern, the worker in the picking station unit ST picks up products from the storage shelves T1, T2, and T3 and stores the products in the shipping shelf H1. In the third disposition combination pattern, when an order for a plurality of different products is received, a plurality of products picked from a plurality of product shelves corresponding to the order can be stored in one shipping shelf H1, and therefore, the determination processing unit 113 selects the third disposition combination pattern, for example, when order information for products with a low shipping frequency (niche product) is acquired. In the second connection pattern (see FIG. 13B) in which the two picking station units ST are connected, five storage shelves T and one shipping shelf H may be disposed around the two picking station units ST, or four storage shelves T and two shipping shelves H may be disposed.

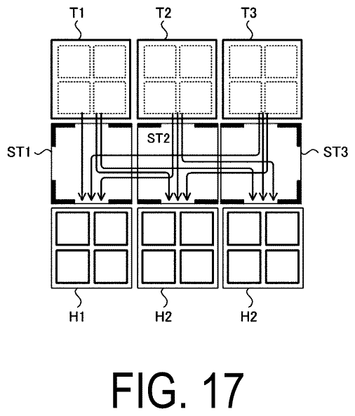

FIG. 17 illustrates a specific example of a fourth disposition combination pattern. The fourth disposition combination pattern is a connection pattern in which, for the three picking station units ST1 to ST3, the storage shelves T1 to T3 are disposed adjacent to the boundary portion 54 of a first side (an upper side of FIG. 17) and the shipping shelves H1 to H3 are disposed adjacent to the boundary portion 54 of a second side (a lower side of FIG. 17). In the fourth disposition combination pattern, the workers in the picking station units ST1 to ST3 pick up products from the storage shelves T1, T2, and T3 and store the products on the shipping shelves H1, H2, and H3. In the fourth disposition combination pattern, when a plurality of orders for different products are received, the products can be stored simultaneously in a plurality of shipping shelves corresponding to the respective orders, the determination processing unit 113 selects the fourth disposition combination pattern, for example, if a plurality of orders including a plurality of products are acquired.

The above-described disposition combination patterns are examples and the present disclosure is not limited thereto, and a plurality of disposition combination patterns corresponding to the connection patterns of the picking station units ST are registered in advance.

As described above, when the determination processing unit 113 selects the connection pattern of the picking station units ST and the disposition combination pattern of the storage shelves T and the shipping shelves H, the determination processing unit 113 determines the disposition positions of the picking station units ST, the storage shelves T, and the shipping shelves H in accordance with the selected connection pattern and disposition combination pattern.

The movement processing unit 114 moves the picking station units ST to the disposition positions. Specifically, the movement processing unit 114 generates a traveling route for moving the picking station unit ST to the disposition position, and outputs a travel instruction to the automatic transport apparatus 2. For example, the movement processing unit 114 outputs a travel instruction including information on the disposition position and the traveling route determined by the determination processing unit 113 to one or more automatic transport apparatuses 2 to cause the automatic transport apparatus 2 to move the plurality of picking station units ST to the disposition position. When the automatic transport apparatus 2 acquires the travel instruction, the automatic transport apparatus 2 moves each of the plurality of picking station units ST in the picking area AR2 along the traveling route to be brought into the disposition state shown in the connection pattern (see FIGS. 13A to 13D).

Further, the movement processing unit 114 moves the storage shelf T and the shipping shelf H to the position corresponding to the disposition combination pattern selected by the determination processing unit 113. Specifically, the movement processing unit 114 generates a traveling route for moving each of the storage shelf T and the shipping shelf H to the position corresponding to the disposition combination pattern, and outputs a travel instruction to the automatic transport apparatus 2. For example, the movement processing unit 114 outputs a travel instruction including information on the disposition position and traveling route corresponding to the disposition combination pattern determined by the determination processing unit 113 to one or more automatic transport apparatuses 2, and causes the automatic transport apparatuses 2 to move the storage shelf T and the shipping shelf H to the disposition position of the disposition combination pattern. When the automatic transport apparatus 2 acquires the travel instruction, the automatic transport apparatus 2 moves the storage shelf T storing the product that is a picking target from the storage area AR1 to the picking area AR2 along the traveling route, and disposes the storage shelf T to be adjacent to the picking station unit ST disposed in the connection pattern (see FIG. 2). Also, when the automatic transport apparatus 2 acquires the travel instruction, the automatic transport apparatus 2 moves the shipping shelf H from the shipping area AR3 to the picking area AR2 along the traveling route, and disposes the shipping shelf H to be adjacent to the picking station unit ST disposed in the connection pattern (see FIG. 2).

When the storage shelves T and the shipping shelves H are disposed around the picking station unit ST in accordance with the disposition combination pattern, the worker performs the picking work in the work space in the picking station unit ST (the work space As1 of one picking station unit ST or the work space As11 of a plurality of picking station units ST) to take out the product that is a picking target (the ordered product) from the storage shelves T and move the product to the shipping shelf H. In the picking work, the controller 11 of the management server 1 turns on the LED 533 of the communication tag 55 (see FIG. 10) corresponding to the storage position of the product that is a picking target in the storage shelf T among the communication tags 55 installed on the arms 53 of the picking station units ST, and displays information such as the product name on the display 532. For example, when the product that is a picking target is stored on a third stage of the storage shelf T, the controller 11 turns on the LED 533 of the communication tag 55 of the third stage of the picking station unit ST to display a product name on the display 532. This improves work efficiency because the worker can easily find the product that is a picking target in the work space. The display 532 may display identification information of the shipping shelf H (such as the number of the shipping shelf H) where the product that is a picking target is to be stored. When the worker stores the products on the shipping shelf H and presses the button of the LED 533, the controller 11 displays the product information of the next product that is a picking target on the communication tag 55.

During the picking work, the automatic transport apparatus 2 performs processing to move other picking station units ST, storage shelves T, and shipping shelves H in response to other travel instructions acquired from the controller 11.

When the worker finishes the picking work, the controller 11 outputs an end instruction to the automatic transport apparatus 2. When the automatic transport apparatus 2 receives the end instruction, the automatic transport apparatus 2 moves the storage shelf T to the storage area AR1 and moves the shipping shelf H to the shipping area AR3.

As described above, the controller 11 dynamically generates a work space for the picking work by moving the picking station unit ST to a predetermined disposition position and also moving the storage shelf T and the shipping shelf H in accordance with the disposition position of the picking station unit ST. The controller 11 may move only one of the storage shelf T and the shipping shelf H relative to the picking station unit ST. For example, the controller 11 may move the picking station unit ST to the position of the storage shelf T storing the product that is a picking target and move the shipping shelf H to the position. The controller 11 may also move the picking station unit ST to the position of the shipping shelf H and move the storage shelf T storing the product that is a picking target to the position.

### Picking Process

Hereinafter, a picking process executed in the picking system 10 according to the present embodiment will be described with reference to FIG. 18. Specifically, in the present embodiment, the picking process is executed by the controller 11 of the management server 1. Further, the controller 11 can execute a plurality of picking processes in parallel in response to a plurality of shipping requests to a plurality of automatic transport apparatuses 2.

The present disclosure can be understood as a disclosure of a picking method that executes one or more steps included in the picking process. Further, the one or more steps included in the picking process to be described here may be omitted appropriately. Further, the steps in the picking process may be executed in a different order as long as the same actions and effects are obtained. Further, although a case in which the controller 11 executes each step in the picking process will be described by way of example, a picking method in which one or more processors execute respective steps in the picking process in a distributed manner is also conceivable as another embodiment. Further, the picking method is a method of supporting the picking work in the picking system 10 including the automatic transport apparatus 2 and the picking station unit ST.

### <Step S1>

First, in step S1, the controller 11 acquires order information. For example, the controller 11 acquires order information (shipping information) for goods (product) from an order server. The controller 11 may acquire a plurality of pieces of order information at once every preset time (cycle).

### <Step S2>

Next, in step S2, the controller 11 selects the connection pattern for the picking station units ST. Specifically, the controller 11 confirms a current shipping frequency, sales level, and the like of the product included in the order information and selects the connection pattern for the picking station units ST. For example, the controller 11 selects a connection pattern with a larger number of picking station units ST (for example, the connection pattern in FIG. 13C or 13D) as a shipping frequency of the ordered product increases, and selects a connection pattern with a smaller number of picking station units ST (for example, the connection pattern in FIG. 13A or 13B) as the shipping frequency of the ordered product decreases.

### <Step S3>

Next, in step S3, the controller 11 selects the disposition combination pattern for the storage shelves T, the picking station units ST, and the shipping shelves H. Specifically, the controller 11 confirms the shipping frequency, sales level, and the like to select the disposition combination pattern. For example, the controller 11 selects the disposition combination pattern (for example, the first disposition combination pattern in FIG. 14) in which a ratio of the number of shipping shelves H to the number of storage shelves T increases as the shipping frequency of the product increases, and selects the disposition combination pattern (for example, the third disposition combination pattern in FIG. 16) in which a ratio of the number of storage shelves T to the number of shipping shelves H increases as the shipping frequency decreases.

### <Step S4>

Next, in step S4, the controller 11 generates a traveling route allowing the automatic transport apparatus 2 to move each of the storage shelves T, the picking station unit ST, and the shipping shelves H. One automatic transport apparatus 2 may move each of the storage shelves T, the picking station unit ST, and the shipping shelves H, or the plurality of automatic transport apparatuses 2 may move each of the storage shelves T, the picking station unit ST, and the shipping shelves H in a distributed manner. The controller 11 generates each traveling route based on a current position of the automatic transport apparatus 2, a current position of each of the storage shelf T, the picking station unit ST, and the shipping shelf H, which are movement targets, and the disposition positions in accordance with the connection pattern and the disposition combination pattern.

### <Step S5>

Next, in step S5, the controller 11 outputs the travel instruction to the automatic transport apparatus 2. Specifically, the controller 11 outputs a travel instruction including the information of the traveling route generated in step S4 to one or more automatic transport apparatuses 2. When the automatic transport apparatus 2 acquires the travel instruction from the management server 1, the automatic transport apparatus 2 moves each of the storage shelf T, the picking station unit ST, and the shipping shelf H to the disposition positions in accordance with the connection pattern and the disposition combination pattern along the traveling route (see FIG. 2).

### <Step S6>

Next, in step S6, the controller 11 determines whether the movement of each of the storage shelf T, the picking station unit ST, and the shipping shelf H has ended. When each of the storage shelf T, the picking station unit ST, and the shipping shelf H arrives at the disposition position (S6: Yes), the controller 11 proceeds to a process of step S7. The controller 11 causes the automatic transport apparatus 2 to continue the transport process until each of the storage shelf T, the picking station unit ST, and the shipping shelf H arrive at the disposition position (S6: No).

### <Step S7>

Next, in step S7, the controller 11 starts the picking work. Specifically, the controller 11 turns on the LED 533 of the communication tag 55 (see FIG. 10) corresponding to a storage position of the product that is a picking target in the storage shelf T, and displays product information such as a product name on the display 532. The worker takes out the product from the storage shelf T at a position at which the LED 533 is turned on and stores the product in the shipping shelf H. When the worker presses the button of the LED 533, the communication tag 55 transmits information indicating the end of the picking work for the one product, and when the controller 11 receives the end information, the controller 11 displays product information of the next picking target on the display 532 and turns on the LED 533.

### <Step S8>

Next, in step S8, the controller 11 determines whether the picking work has ended. Specifically, when all the products included in the order information are stored from the storage shelf T to the shipping shelf H, the controller 11 determines that the picking work has ended (S8: Yes) and proceeds to a process of step S9. The controller 11 continues the process until the picking work ends (S8: No).

### <Step S9>

Next, in step S9, the controller 11 generates a traveling route allowing the automatic transport apparatus 2 to move each of the storage shelf T, the picking station unit ST, and the shipping shelf H. For example, the controller 11 generates a traveling route for moving the shipping shelf H to a predetermined position (shipping place) in the shipping area AR3. Further, the controller 11 generates a traveling route for moving the storage shelf T to a predetermined position (for example, any free space) in the storage area AR1. Further, the controller 11 generates a traveling route for moving the picking station unit ST to a predetermined position (for example, any free space) in the picking area AR2. The controller 11 may determine a movement destination of the storage shelf T and the picking station unit ST based on the next order information to generate the traveling route.

### <Step S10>

Next, in step S10, the controller 11 outputs the travel instruction to the automatic transport apparatus 2. Specifically, the controller 11 outputs a travel instruction including the information of the traveling route generated in step S9 to one or more automatic transport apparatuses 2. When the automatic transport apparatus 2 acquires the travel instruction from the management server 1, the automatic transport apparatus 2 moves each of the storage shelf T, the picking station unit ST, and the shipping shelf H to a predetermined position along the traveling route.

### <Step S11>

Next, in step S11, the controller 11 determines whether the movement of each of the storage shelf T, the picking station unit ST, and the shipping shelf H has ended. When each of the storage shelf T, the picking station unit ST, and the shipping shelf H arrives at the predetermined position (S11: Yes), the controller 11 proceeds to a process of step S1. The controller 11 causes the automatic transport apparatus 2 to continue the transport process until each of the storage shelf T, the picking station unit ST, and the shipping shelf H arrives at the predetermined position (S11: No).

The controller 11 repeatedly executes the above-described process each time the order information is acquired. Further, when the controller 11 acquires a plurality of pieces of order information at the same time, the controller 11 controls the plurality of automatic transport apparatuses 2 to execute the above-described process in parallel.

As described above, the picking system 10 according to the present embodiment is a picking system including the automatic transport apparatus 2 that transports goods and the picking station unit ST where the worker boards to perform picking work on the goods. The picking system 10 also includes the determination processing unit 113 that determines the disposition position of the picking station unit ST, and the movement processing unit 114 that moves the picking station unit ST to the disposition position. The determination processing unit 113 and the movement processing unit 114 are included in, for example, the management server 1.

Further, the picking station unit ST (see FIG. 6) includes a stage 51 where the worker boards, a pillar 52 located at an end portion of the stage 51 and extending upward from the stage 51, and an arm 53 extending laterally from the pillar 52 along a boundary portion 54 between an area of the stage 51 and an area outside the stage 51.

Further, a plurality of picking station units ST that are disposed to be adjacent to each other can be connected to each other, and a single work space As11 is formed inside the plurality of connected picking station units ST (see FIGS. 13B to 13D).

Further, the determination processing unit 113 selects one connection pattern from among the plurality of preregistered connection patterns of the picking station units ST, and determines the disposition positions of the plurality of picking station units ST.

Further, the determination processing unit 113 selects one disposition combination pattern from among a plurality of preregistered disposition combination patterns of the storage shelves T and the shipping shelves H. The movement processing unit 114 causes the automatic transport apparatus 2 to move the storage shelves T and the shipping shelves H to positions corresponding to the disposition combination pattern.

According to the above configuration, a position (place) of the work space where the worker performs the picking work can be dynamically changed. For example, the picking station unit ST can be moved close to the storage shelf T to perform the picking work. Further, the disposition position of the picking station unit ST can be determined depending on, for example, the shipping frequency and sales level of the product that is a picking target. Also, the storage shelf T and the shipping shelf H can be moved in accordance with the disposition position of the picking station unit ST. This can prevent a long standby time until the storage shelf T arrives at the picking station unit ST. Further, it is possible to shorten the time required for replacing the storage shelf T. Therefore, it is possible to improve the efficiency of the picking work.

Further, with the above configuration, since a space surrounded by the stage 51, the pillar 52, and the arm 53 of the picking station unit ST can be secured as the work space for the picking work, it is possible to improve the safety of the worker performing the picking work.

As another embodiment of the picking system 10, each picking station unit ST may include a traveling device that moves the picking station unit ST on the floor surface. In other words, the picking station unit ST may include an automatic traveling function.

The controller 11 of the management server 1 controls the entire management server 1. The controller 11 realizes various functions by reading and executing various programs stored in the storage 12 (for example, storage or ROM). The controller 11 may be implemented by one or multiple control devices/arithmetic devices (such as a Central Processing Unit (CPU), a System on a Chip (SoC)). In addition, the controller 11 may include one or multiple control circuits (electronic circuits).

### Supplement 1 to Disclosure

The following is a supplementary description of an overview of the disclosure extracted from the picking system 10 according to the above-described embodiment. Configurations and processing functions described in the following supplements can be selected and combined as desired.

### <Supplement 1>

A picking system comprising
an automatic transport apparatus that transports goods;
picking station units where a worker boards to perform picking work on the goods;
a determination processing circuit that determines disposition positions of the picking station units, and
a movement processing circuit that moves the picking station units to the disposition positions.

### <Supplement 2>

The picking system described in supplement 1, in which the picking station units disposed to be adjacent to each other can be connected to each other, and
the determination processing circuit selects one connection pattern from among a plurality of preregistered connection patterns of the picking station units to determine disposition positions of a plurality of picking station units.

### <Supplement 3>

The picking system described in supplement 2, in which the determination processing circuit selects one connection pattern from among the plurality of preregistered connection patterns based on attribute information of goods that are picking targets.

### <Supplement 4>

The picking system described in supplement 2 or 3, in which the plurality of preregistered connection patterns include a plurality of connection patterns with a different number of the picking station units to be connected.

### <Supplement 5>

The picking system described in supplement 2 or 3, in which a space in which the worker can move is formed within the plurality of picking station units to be connected.

### <Supplement 6>

The picking system described in any of supplements 1 to 5, in which the picking station unit is configured to allow at least one of a storage shelf storing the goods and a shipping shelf storing the goods picked from the storage shelf to be disposed adjacent to the picking station unit.

### <Supplement 7>

The picking system described in supplement 6, in which the determination processing circuit selects one disposition combination pattern from among the plurality of preregistered disposition combination patterns, and
the movement processing circuit causes the automatic transport apparatus to move the shelf to a position corresponding to the disposition combination pattern selected by the determination processing circuit.

### <Supplement 8>

The picking system described in supplement 7, in which the plurality of preregistered disposition combination patterns include a plurality of disposition combination patterns with a different ratio of the number of the storage shelves to the number of the shipping shelves.

### <Supplement 9>

The picking system described in supplement 7 or 8, in which the determination processing circuit selects one disposition combination pattern from among the plurality of disposition combination patterns based on attribute information of the goods.

### <Supplement 10>

The picking system described in any of supplements 1 to 9, in which the movement processing circuit causes the automatic transport apparatus to move the picking station unit to the disposition position.

### <Supplement 11>

The picking system described in any of supplements 1 to 10, in which the picking station unit includes a traveling device that moves the picking station unit to the disposition position.

### <Supplement 12>

A picking method for supporting picking work in a system including an automatic transport apparatus that transports goods and a picking station unit where a worker boards to perform picking work on the goods, in which one or more processors executes determining a disposition position of the picking station unit; and
moving the picking station unit to the disposition position.

### <Supplement 13>

A picking program for supporting picking work in a system including an automatic transport apparatus that transports goods and a picking station unit where a worker boards to perform picking work on the goods, the picking program causing one or more processors to execute
determining a disposition position of the picking station unit, and
moving the picking station unit to the disposition position, or
a non-transitory computer-readable recording medium having the picking program recorded thereon.

### Supplement 2 to Disclosure

The following is a supplementary description of an overview of the disclosure extracted from the picking station unit ST according to the above-described embodiment. Configurations and processing functions described in the following supplements can be selected and combined as desired.

### <Supplement 1>

A picking station unit where a worker boards to perform picking work on goods, including:
a stage where the worker boards;
a pillar located at an end portion of the stage and extending upward from the stage; and
an arm extending laterally from the pillar along a boundary portion between an area of the stage and an area outside the stage.

### <Supplement 2>

The picking station unit described in supplement 1, in which the pillar includes a first pillar located at a first end portion of the stage and a second pillar located at a second end portion of the stage, and
the arm includes a first arm extending laterally from the first pillar along a first boundary portion between the first pillar and the second pillar, and a second arm extending laterally from the second pillar along the first boundary.

### <Supplement 3>

The picking station unit described in supplement 1 or 2, in which the stage has a shape of a polygon in top view, the pillar is disposed at each of a plurality of corner portions of the polygon in the stage, and
the boundary portion is formed between the plurality of adjacent pillars.

### <Supplement 4>

The picking station unit described in any of supplements 1 to 3, in which the arm is changeable between a first state in which the arm extends horizontally from the pillar along the boundary portion and a second state in which the arm extends vertically along the pillar.

### <Supplement 5>

The picking station unit described in supplement 4, in which the worker can move across the boundary portion between an area of the stage and an area outside the stage when the arm is in the second state.

### <Supplement 6>

The picking station unit described in any one of supplements 1 to 5, in which the first picking station unit and the second picking station unit can be connected via the boundary portion of the first picking station unit and the boundary portion of the second picking station unit.

### <Supplement 7>

The picking station unit described in supplement 6, in which a space in which the worker can move is formed inside the first picking station unit and the second picking station unit to be connected.

### <Supplement 8>

The picking station unit described in any one of supplements 1 to 7, in which at least one of a storage shelf storing the goods and a shipping shelf storing the goods picked from the storage shelf can be disposed adjacent to the boundary portion.

### <Supplement 9>

The picking station unit described in any one of supplements 1 to 8, in which the arm is provided with a display that displays information regarding the picking work.

### <Supplement 10>

The picking station unit described in any of supplements 1 to 9, in which the picking station unit includes an entrance portion through which an automatic transport apparatus can enter between the stage and a floor surface on which the picking station unit is disposed, and
the picking station unit can move on the floor surface according to a traveling operation of the automatic transport apparatus that has entered the entrance portion.

### <Supplement 11>

The picking station unit described in any of supplements 1 to 10, in which the picking station unit includes a traveling device that moves the picking station unit on the floor surface.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A picking system comprising:
an automatic transport apparatus that transports goods;
picking station units where a worker boards to perform picking work on the goods; and
one or more processors,
wherein one or more processors are configured to
determine disposition positions of the picking station units, and
move the picking station units to the disposition positions.

2. The picking system according to claim 1,
wherein the picking station units disposed to be adjacent to each other can be connected to each other, and
the one or more processors select one connection pattern from among a plurality of preregistered connection patterns of the picking station units to determine disposition positions of a plurality of picking station units.

3. The picking system according to claim 2, wherein the one or more processors select one connection pattern from among the plurality of preregistered connection patterns based on attribute information of goods that are picking targets.

4. The picking system according to claim 2, wherein the plurality of preregistered connection patterns include a plurality of connection patterns with a different number of the picking station units to be connected.

5. The picking system according to claim 2, wherein a space in which the worker moves is formed within the plurality of picking station units to be connected.

6. The picking system according to claim 1, wherein the picking station unit is configured to allow at least one of a storage shelf storing the goods and a shipping shelf storing the goods picked from the storage shelf to be disposed adjacent to the picking station unit.

7. The picking system according to claim 6, wherein the one or more processors
select one disposition combination pattern from among a plurality of preregistered disposition combination patterns of the shelf, and
cause the automatic transport apparatus to move the shelf to a position corresponding to the selected disposition combination pattern.

8. The picking system according to claim 7, wherein the plurality of preregistered disposition combination patterns include a plurality of disposition combination patterns with a different ratio of the number of the storage shelves to the number of the shipping shelves.

9. The picking system according to claim 7, wherein the one or more processors select one disposition combination pattern from among the plurality of disposition combination patterns based on attribute information of the goods.

10. The picking system according to claim 1, wherein the one or more processors cause the automatic transport apparatus to move the picking station unit to the disposition position.

11. The picking system according to claim 1, wherein the picking station unit includes a traveling device that moves the picking station unit to the disposition position.

12. A picking method for supporting picking work, which is executed by one or more processors, in a system including an automatic transport apparatus that transports goods and a picking station unit where a worker boards to perform picking work on the goods, the picking method comprising:
determining a disposition position of the picking station unit; and
moving the picking station unit to the disposition position.

13. A non-transitory computer-readable recording medium having a picking program recorded thereon to support picking work in a system including an automatic transport apparatus that transports goods and a picking station unit where a worker boards to perform picking work on the goods, the picking program causing one or more processors to execute
determining a disposition position of the picking station unit, and
moving the picking station unit to the disposition position.
